(19) United States
(12) Patent Application Publication
(10) Pub. No.: US 2016/0218428 A1
(43) Pub. Date: Jul. 28, 2016

(54) APPARATUS FOR CALIBRATING ARRAY ANTENNA SYSTEM AND METHOD THEREOF

(71) Applicant: ELECTRONICS AND TELECOMMUNICATIONS RESEARCH INSTITUTE, Daejeon (KR)

(72) Inventors: Jae Ho JUNG, Daejeon (KR); Heon Kook KWON, Daejeon (KR); Bong Hyuk PARK, Daejeon (KR)

(73) Assignee: Electronics and Telecommunications Research Institute, Daejeon (KR)

(21) Appl. No.: 14/993,502

(22) Filed: Jan. 12, 2016

(30) Foreign Application Priority Data
Jan. 26, 2015 (KR) 10-2015-0012243

(51) Int. Cl. H01Q 3/26

(52) U.S. Cl. CPC H01Q 3/267

(57) ABSTRACT

An error calibrating apparatus of an array antenna system according to an exemplary embodiment of the present invention is an error calibrating apparatus of an array transmitting antenna system having a plurality of array antennas and includes a calibrating signal generator which generates an error calibrating signal as a single frequency signal, in an area which does not interfere with a passband of a transmitted signal; an array RF transmitter which upwardly converts the transmitted signal into an RF band to transmit the signal to the plurality of array antennas; an error calibration estimator which correlates the error calibrating signal and the receiving single frequency signal received by passing through the array RF transmitter to estimate a transfer function of the array RF transmitter and extract a filter coefficient using the estimated transfer function; and a complex filter which calibrates an error of the transmitted signal by applying the filter coefficient to output the corrected transmitted signal to the array RF transmitter.

### CROSS-REFERENCE TO RELATED APPLICATIONS

This application claims priority to and the benefit of Korean Patent Application No. 10-2015-0012243 filed in the Korean Intellectual Property Office on Jan. 26, 2015, the entire contents of which are incorporated herein by reference.

### TECHNICAL FIELD

The present invention relates to an array antenna system calibrating apparatus and a method thereof, and more particularly, to a technology which generates an error calibrating signal while not interfering with a transmitted signal or a received signal to calibrate an array error of an array transmitting antenna and an array receiving antenna.

### BACKGROUND ART

Generally, an adaptive array antenna system which adaptively directs an antenna beam to a desired direction using an array antenna in a wireless communication system increases an antenna gain, to improve a signal-to-noise ratio.

Like a mobile communication base station system, in an adaptive array antenna system which is implemented by a digital beam forming method in order to simultaneously transmit and receive several different kinds of signals, an independent antenna beam is formed for every signal, so that an interference by other signals may be reduced.

Generally, when it is desired to form a beam using an array antenna, the same signal needs to be applied to individual antenna elements of the array antenna and when it is desired to change an angle of the formed beam, the angle of the beam may be changed in a desired direction only by multiplying the applied signal and a linear phase value.

A precondition required to perform the above-mentioned function is that an RF transceiver needs to be connected to each antenna element of the array antenna and the RF transceivers need to have the same transfer function characteristic. However, most of the RF transceivers are implemented by an active element and operate at a several GHz band, so that the transfer functions are significantly varied due to an error at the time of manufacturing. Further, since the transfer function characteristic changes due to a temperature as time elapses, a device which continuously tracks the transfer function characteristic so as to maintain the same transfer function value is required and the device is referred to as an error calibrating apparatus of an array transceiving system.

In an error calibrating technology of the related art, data which has been already known is forcibly applied to a transceiver to be estimated to measure a transfer function of each of the transceivers. According to this method, a noise signal is added in addition to an actually transmitted or received signal, so that the signals interfere with each other.

Data which is used to calibrate an error according to the related art mainly uses a PN signal or a CAZAC signal in order to generate a signal having an excellent correlation property. In this case, as described above, the PN signal or the CAZAC signal actually acts as an interference signal while operating the communication system. In order to avoid the interference, it needs to endure a loss in that a calibrating time when communication is not performed for a predetermined time is separately allocated to perform calibration and then perform the communication.

Accordingly, a technology which generates an error calibrating signal which does not cause interference while operating the communication system to calibrate a transfer function error of the array transmitting antenna system and the array receiving antenna system therethrough is required.

### SUMMARY OF THE INVENTION

The present invention has been made in an effort to provide an error calibrating apparatus of an array antenna system which provides an error calibrating signal which does not cause interference to a transmitting or received signal while operating the communication system to increase accuracy for calibrating an error and a method thereof.

An error calibrating apparatus of an array antenna system according to an exemplary embodiment of the present invention is an error calibrating apparatus of an array transmitting antenna system having a plurality of array antennas, including: a calibrating signal generator which generates an error calibrating signal as a single frequency signal, in an area which does not interfere with a passband of a transmitted signal; an array RF transmitter which upwardly converts the transmitted signal into an RF band to transmit the signal to the plurality of array antennas; an error calibration estimator which correlates the error calibrating signal and the receiving single frequency signal received by passing through the array RF transmitter to estimate a transfer function of the array RF transmitter and extract a filter coefficient using the estimated transfer function; and a complex filter which calibrates an error of the transmitted signal by applying the filter coefficient to output the corrected transmitted signal to the array RF transmitter.

The error calibrating apparatus of an array antenna system according to the exemplary embodiment of the present invention may further include: a modulator which outputs a subcarrier transmitted signal at a passband; an adder which adds the subcarrier transmitted signal of the passband output from the modulator and the error calibrating signal output from the calibrating signal generator; and a beam former which multiples a weight and a transmitted signal by being added by the adder.

The calibrating signal generator may generate at least one of both end single frequency signals of the passband of the transmitted signal or a DC component signal as the error calibrating signal.

The calibrating signal generator may generate the single frequency signal so as to have the same interval as an interval of subcarriers in the passband of the transmitted signal.

The error calibration estimator may include a single frequency correlator which correlates the error calibrating signal and a receiving single frequency signal output from the array RF transmitter; a transfer function estimator which estimates a transfer function in accordance with the correlation result; a transfer function interpolator which interpolates the transfer function; a filter coefficient extractor which extracts a filter coefficient from the interpolated transfer function; and a storing unit which stores the filter coefficient.

The apparatus may further include an RF receiver which downwardly converts the transmitted signal which is received from the array RF transmitter; and an RF switch which sequentially connects the array RF transmitter and the RF receiver.

An error calibrating apparatus of an array antenna system of the present invention is an error calibrating apparatus of an array receiving antenna system having a plurality of array antennas, including: a calibrating signal generator which generates an error calibrating signal as a single frequency signal, in an area which does not interfere with a passband of a received signal received from the plurality of array antennas; an adder which couples the error calibrating signal and the received signal; an array RF receiver which converts the coupled received signal into a base band signal; an array complex filter which calibrates an error of the received signal transmitted from the array RF receiver; and an error calibration estimator which correlates the error calibrating signal and a received single frequency signal which is received from the array complex filter to estimate a transfer function of the array RF receiver, and extracts a filter coefficient of the array complex filter using the estimated transfer function.

The apparatus may further include an RF transmitter which upwardly converts the error calibration signal output from the calibrating signal generator into an RF band; and an RF divider which transmits the error calibrating signal which is received from the RF transmitter to the adder.

The calibrating signal generator may generate at least one of single frequency signals of both ends of the passband of the received signal or a DC component signal as the error calibrating signal.

The calibrating signal generator may generate the single frequency signal so as to have the same interval as an interval of subcarriers in the passband of the received signal.

The error calibration estimator may include a single frequency correlator which correlates the error calibrating signal and a receiving single frequency signal output from the array RF receiver; a transfer function estimator which estimates a transfer function in accordance with the correlation result; a transfer function interpolator which interpolates the transfer function; a filter coefficient extractor which extracts a filter coefficient from the interpolated transfer function; and a storing unit which stores the filter coefficient.

An error calibrating method of an array antenna system according to an exemplary embodiment of the present invention may include: generating a transmitted signal having a passband subcarrier; generating an error calibrating signal as a single frequency signal, in an area which does not interfere with a passband of the transmitted signal; outputting the transmitted signal to the array RF transmitter: correlating the error calibrating signal and a transmitted signal output from the array RF transmitter; estimating a transfer function of the array RF transmitter in accordance with the correlation result; interpolating the transfer function; extracting a filter coefficient from the interpolated transfer function; and applying the filter coefficient to the complex filter to perform calibration.

The method may further include coupling the error calibrating signal and the transmitted signal; and filtering the coupled transmitted signal in the complex filter.

In the generating of an error calibrating signal, at least one of single frequency signals of both ends of the passband of the transmitted signal or a DC component signal may be generated as the error calibrating signal.

In the generating of an error calibrating signal, the single frequency signal may be generated so as to have the same interval as an interval of subcarriers in the passband of the transmitted signal.

An error calibrating method of an array antenna system according to the present invention may include: receiving a received signal having a passband subcarrier; generating an error calibrating signal as a single frequency signal, in an area which does not interfere with a passband of the received signal; coupling the error calibrating signal and the received signal to transmit the coupled signal to an array RF receiver; converting the coupled received signal to a base band in the array RF receiver; filtering the converted received signal in a complex filter; correlating an output signal of the complex signal and the error calibrating signal to estimate a transfer function of the array RF receiver; interpolating the transfer function; extracting a filter coefficient from the interpolated transfer function; and applying the filter coefficient to the complex filter to perform calibration.

In the generating of an error calibrating signal, at least one of single frequency signals of both ends of the passband of the received signal or a DC component signal may be generated as the error calibrating signal.

In the generating of an error calibrating signal, the single frequency signal may be generated so as to have the same interval as an interval of subcarriers in the passband of the received signal.

The present technology uses a single frequency signal which does not interfere with a transmitting and received signal during operation of a communication system as an error calibrating signal to increase accuracy for calibrating an error.

### BRIEF DESCRIPTION OF THE DRAWINGS

FIG. 1 is a diagram of an array transmitting antenna system including an error calibrating apparatus according to an exemplary embodiment of the present invention.

FIG. 2 is a diagram of an array receiving antenna system including an error calibrating apparatus according to an exemplary embodiment of the present invention.

FIG. 3 is a detailed diagram illustrating an error calibrating apparatus according to an exemplary embodiment of the present invention.

FIG. 4A is a view illustrating an OFDM signal having Nsc subcarriers according to an exemplary embodiment of the present invention.

FIG. 4B is a view illustrating an error calibrating signal which is set so as not to interfere with an OFDM signal according to an exemplary embodiment of the present invention.

FIG. 4C is a view illustrating an example in which a subcarrier of FIG. 4A and an error calibrating signal of FIG. 4B are added, according to an exemplary embodiment of the present invention.

FIG. 5 is a flowchart illustrating an error calibrating method of an array transmitting antenna system according to an exemplary embodiment of the present invention.

FIG. 6 is a flowchart illustrating an error calibrating method of an array receiving antenna system according to an exemplary embodiment of the present invention.

FIG. 7 is a diagram of system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the most preferred exemplary embodiments of the present invention will be described in detail with reference to the accompanying drawings so that those skilled in the art may easily carry out the technical spirit of the present invention.

The present invention generates and provides an error calibrating signal which does not interfere with a signal of a passband to estimate an exact transfer function, thereby increasing accuracy for calibrating an error.

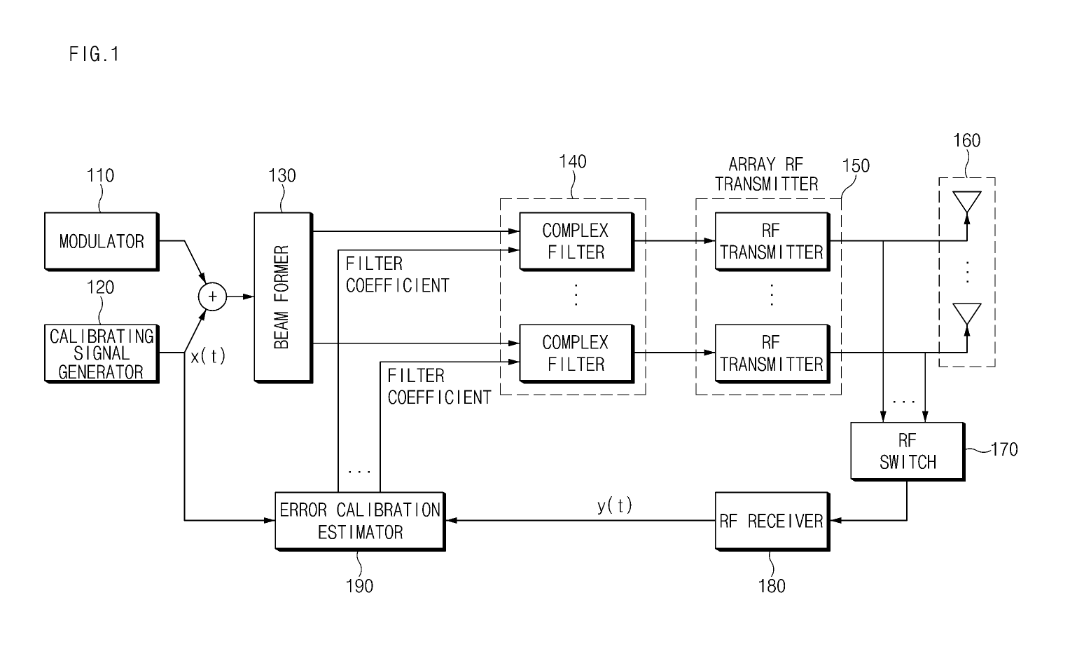

Hereinafter, exemplary embodiments of the present invention will be specifically described with reference to FIGS. 1 to 6.

FIG. 1 is a diagram of an array transmitting antenna system including an error calibrating apparatus according to an exemplary embodiment of the present invention and a diagram for transmitting a signal.

An array transmitting antenna system including an error calibrating apparatus according to an exemplary embodiment of the present invention includes a modulator 110, an adder 115, a calibrating signal generator 120, a beam former 130, an array complex filter 140, an array RF transmitter 150, an array antenna 160, an RF switch 170, an RF receiver 180, and an error calibration estimator 190.

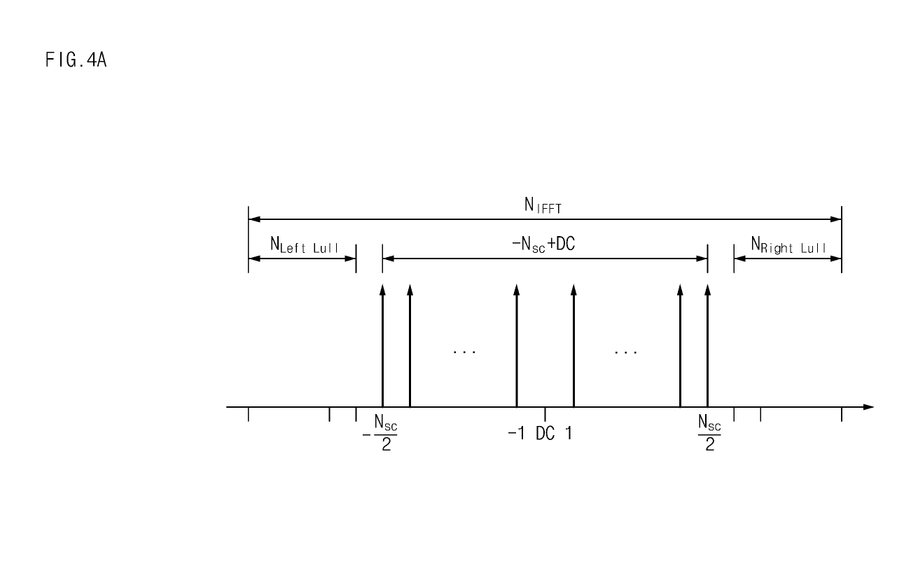

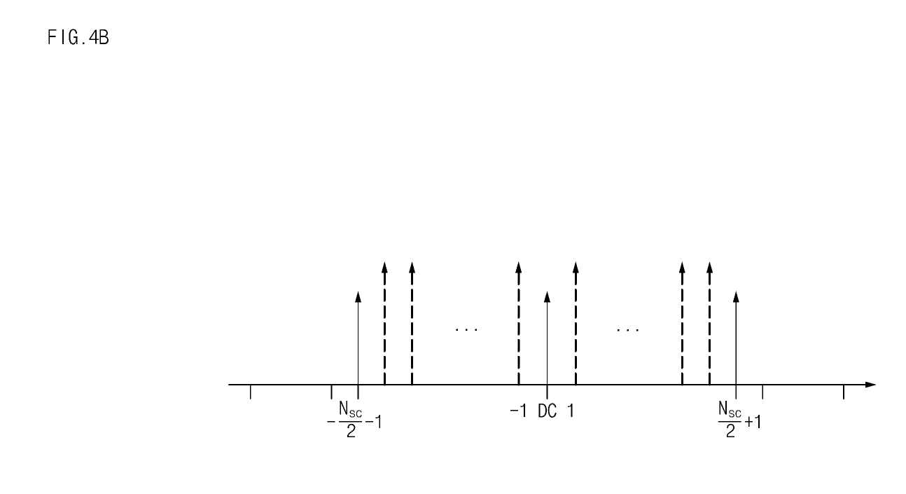

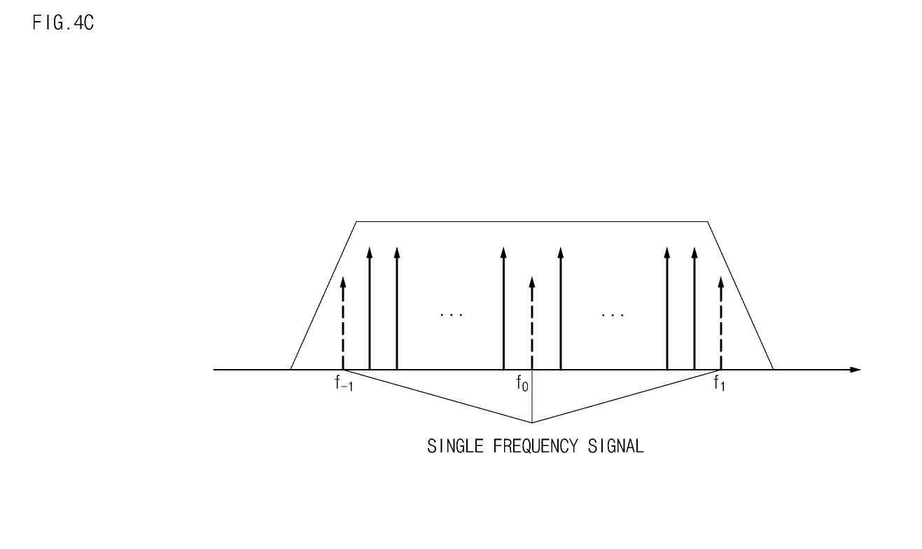

The modulator 110 outputs a passband transmitted signal. As illustrated in FIG. 4A, the passband transmitted signal is configured by Nsc subcarriers.

The calibrating signal generator 120 generates an error calibrating signal x(t) in an area which does not interfere with a passband of a transmitted signal which is output by the modulator 110. As illustrated in FIG. 4B, two single frequency signals and a DC component signal are generated at both sides of the passband as an error calibrating signal so as not to interfere with the passband of FIG. 4A. In this case, the error calibrating signal of the present invention is a single frequency signal which does not interfere with the passband and is very proximate to the passband in a frequency domain without interfering with the transmitted signal, so that the error calibrating signal is not distorted by a complex filter to be transmitted and received.

The adder 115 adds the passband transmitted signal output from the modulator 110 and the error calibrating signal generated in the calibrating signal generator 120 to output the signals. FIG. 4C is a view illustrating an example in which a passband subcarrier of FIG. 4A and an error calibrating signal of FIG. 4B are added.

The beam former 130 multiplies a beam forming weight and a transmitted signal output from the adder 115 to be directed to an incoming direction of the transmitted signal.

The array complex filter 140 applies a filter coefficient transmitted by the error calibration estimator 190 to filter the transmitted signal output from the beam former 130.

The array RF transmitter 150 transmits the transmitted signal received from the array complex filter 140 to the array antenna 160. In this case, the array RF transmitter 150 converts a digital signal to be transmitted into an analog signal and upwardly convers the analog signal into an RF band.

The array antenna 160 includes a plurality of radiating elements and transmits the transmitted signal transmitted from the array RF transmitter 150 to the outside.

The RF switch 170 sequentially connects the array RF transmitter 150 and the RF receiver 180.

The RF receiver 180 downwardly converts the transmitted signal which is upwardly converted by the array RF transmitter 150 to transmit the signal to the error calibration estimator 190.

The error calibration estimator 190 correlates a received single frequency signal y(t) which is downwardly converted and received from the RF receiver 180 and an error calibrating signal x(t) which is generated in the calibrating signal generator 120 to estimate the transfer function of the array RF transmitter 150 for every channel Thereafter, the error calibration estimator 190 performs inverse Fourier transform on the transfer function to extract a filter coefficient and transmits the extracted filter coefficient to the array complex filter 140.

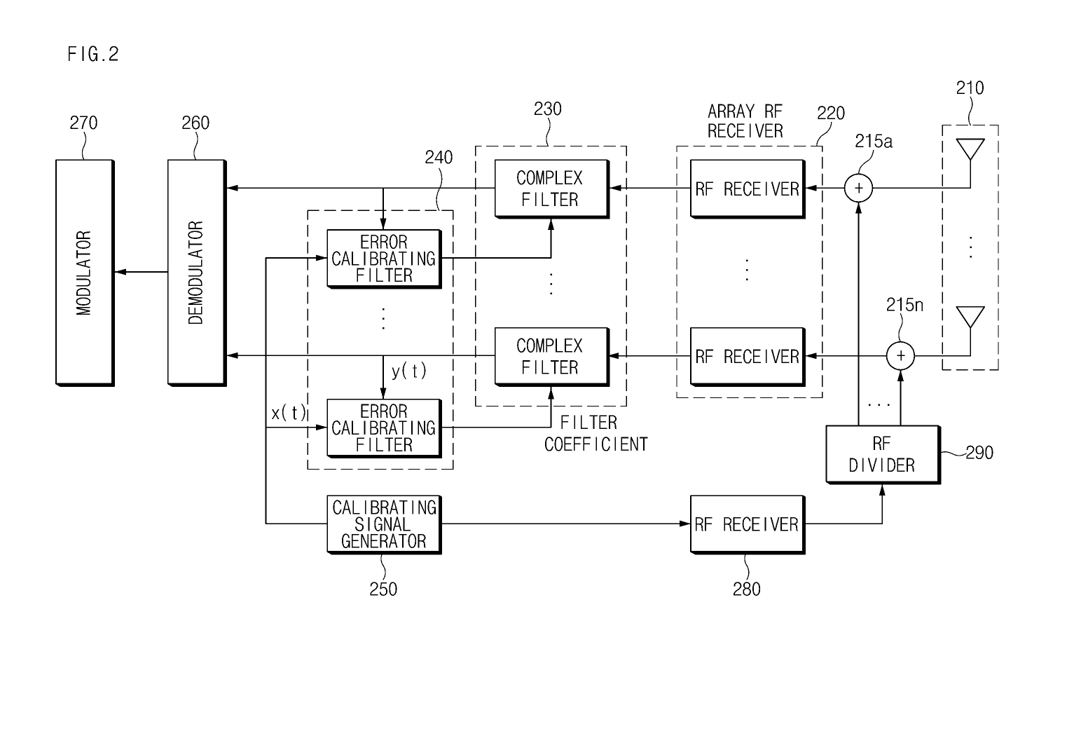

FIG. 2 is a diagram of an array receiving antenna system including an error calibrating apparatus according to an exemplary embodiment of the present invention and a diagram for receiving a signal.

An array receiving antenna system including an error calibrating apparatus according to an exemplary embodiment of the present invention includes an array antenna 210, adders 215a to 215n, an array RF receiver 220, an array complex filter 230, an array error calibration estimator 240, a calibrating signal generator 250, a beam former 260, an base band signal generator 270, an RF transmitter 280, and an RF divider 290.

The array antenna 210 includes a plurality of radiating elements to receive a radio frequency (hereinafter, abbreviated as an “RF”) band signal from the outside.

The array RF receiver 220 downwardly converts the RF band signal which is received by the array antenna 210 into a baseband signal and converts the analog signal into a digital signal to transmit the signal to the array complex filter 230.

The array complex filter 230 applies a filter coefficient transmitted by the array error calibration estimator 240 to calibrate the received signal received from the array RF receiver 220 by filtering the received signal.

The array error calibration estimator 240 correlates an error calibrating signal x(t) output from the calibrating signal generator 250 and a received single frequency signal y(t) received from the array complex filter 230 to estimate the transfer function of the array RF receiver 220 for every channel Thereafter, the array error calibration estimator 240 performs inverse Fourier transform on the transfer function to extract a filter coefficient and transmits the extracted filter coefficient to the array complex filter 230.

The calibrating signal generator 250 generates the error calibrating signal x(t) in an area which does not interfere with the passband of the received signal and transmits the signal to the array error calibration estimator 240 and the RF transmitter 280. In this case, as illustrated in FIG. 4B, two single frequency signals and a DC component signal are generated at both sides of the passband as an error calibrating signal so as not to interfere with the passband of FIG. 4A.

The beam former 230 causes the filtered received signals which are received from the array complex filter 230 to be directed to incoming directions of different signals.

A demodulator 270 demodulates the received signal which is transmitted by the beam former 260.

The RF transmitter 280 upwardly converts the error calibrating signal output from the calibrating signal generator 250 into the RF band to transmit the signal to the RF divider 290.

The RF divider 290 transmits the error calibrating signal received from the RF transmitter 280 to the adders 215a to 215n so as to be coupled to the received signal received from the array antenna 210.

The adder 215a to 215n couples the error calibrating signal received from the RF divider 290 with the received signal received from the array antenna 210. Referring to FIG. 4C, two single frequency signals and a DC component signal are generated at both sides other than the passband, as an error calibrating signal and the single frequency signals are generated so as to have the same interval as an interval of the subcarriers.

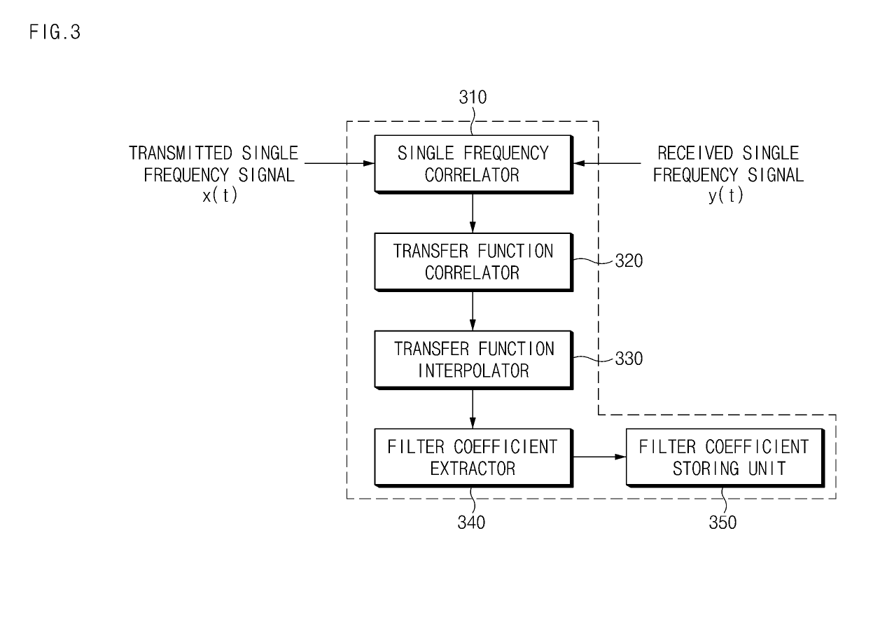

FIG. 3 is a detailed diagram illustrating an error calibration estimator 190 or 240 according to an exemplary embodiment of the present invention.

Referring to FIG. 3, the error calibration estimator 190 or 240 according to an exemplary embodiment of the present invention includes a single frequency correlator 310, a transfer function estimator 320, a transfer function interpolator 330, a filter coefficient extractor 340, and a filter coefficient storing unit 350.

The single frequency correlator 310 correlates the transmitted single frequency signal (error calibrating signal) x(t) and the received single frequency signal y(t) to determine a similarity of the transmitted single frequency signal and the received single frequency signal. In this case, the transmitted single frequency signal which is input to the error calibration estimator 190 which is applied to the array transmitting antenna system according to the exemplary embodiment of the present invention of FIG. 1 is an error calibrating signal which is received from the calibrating signal generator 120 and the received single frequency signal means a received signal received by the RF receiver 180. Further, the transmitted single frequency signal which is input to the error calibration estimator 240 which is applied to the array receiving antenna system according to the exemplary embodiment of the present invention of FIG. 2 is an error calibrating signal which is received from the calibrating signal generator 250 and the received single frequency signal means a received signal received by the complex filter 230.

The transfer function estimator 320 estimates the transfer function in accordance with a correlation result of the single frequency correlator 310. In this case, a difference between the transmitted single frequency signal and the received single frequency signal may be estimated as the transfer function. In this case, the transfer function estimator 320 estimates a transfer function from at least three single frequencies.

The transfer function interpolator 330 performs interpolation using three or more single frequency signals, so that the transfer function has a band characteristic.

The filter coefficient extractor 340 inversely converts the transfer function to extract the filter coefficients of the complex filters 140 and 230. In this case, the filter coefficient of the complex filter may be calculated using inverse Fourier transform.

The filter coefficient storing unit 350 stores a filter coefficient extracted from the filter coefficient extractor 340.

The error calibration estimators 190 or 240 having a configuration as illustrated in FIG. 3 uses the following Equation in order to calibrate an error of the single frequency signal.

When the transmitted single frequency signal is ×(t)=exp(j2πf₀t) and the received single frequency signal is y(t), the transfer function may be expanded as represented by the following Equation 1.

y(t)=h(t)*x(t) Equation 1

Here, h(t) is a frequency domain signal, that is, a transfer function and * means a conjugate.

When Equation 1 is expanded with respect to x(t−τ), the following Equation 2 is obtained.

$$y ( t ) = {{\int }_{- ∞}}^{∞} h ( τ ) \times ( t - τ ) \qquad Equation 2$$

When x(t−τ)=exp(j2πf₀(t−τ) is substituted into Equation 2, it is expanded as represented in the following Equation 3.

$$\begin{matrix}y ( t ) = {{\int }_{- ∞}}^{∞} h ( τ ) exp [ j 2 π {f}_{0} ( t - τ ) ] d τ \\ = exp ( j 2 π {f}_{0} t ) {{\int }_{- ∞}}^{∞} h ( τ ) exp ( - j 2 π {f}_{0} τ ) d τ\end{matrix} \qquad Equation 3$$

When Equation 3 is expanded with respect to H(f₀), a transfer function for f₀ is obtained as represented in the following Equation 4.

H(f₀)=y(t)exp(−j2πf₀t) Equation 4

In Equation 4, not only f₀, but also a transfer function for f₋₁, f₁ corresponding to both sides other than the passband which does not interfere with the passband signal in FIG. 4C may be calculated.

Therefore, the transfer function with respect to the single frequency signal may be extracted from a frequency characteristic of the single frequency signal which is received without being synchronized and the transfer functions are estimated for every three single frequency signals and the estimated transfer functions are estimated so as to have a frequency characteristic in the band by the transfer function interpolator 330.

As described above, when the transfer function in the passband is estimated, the filter coefficient is extracted through inverse Fourier transform and the extracted filter coefficient is applied to the complex filter 140 or 230.

Therefore, the complex filter 140 or 230 calibrates errors of the received signal and the transmitted signal by filtering the signal with the applied filter coefficient.

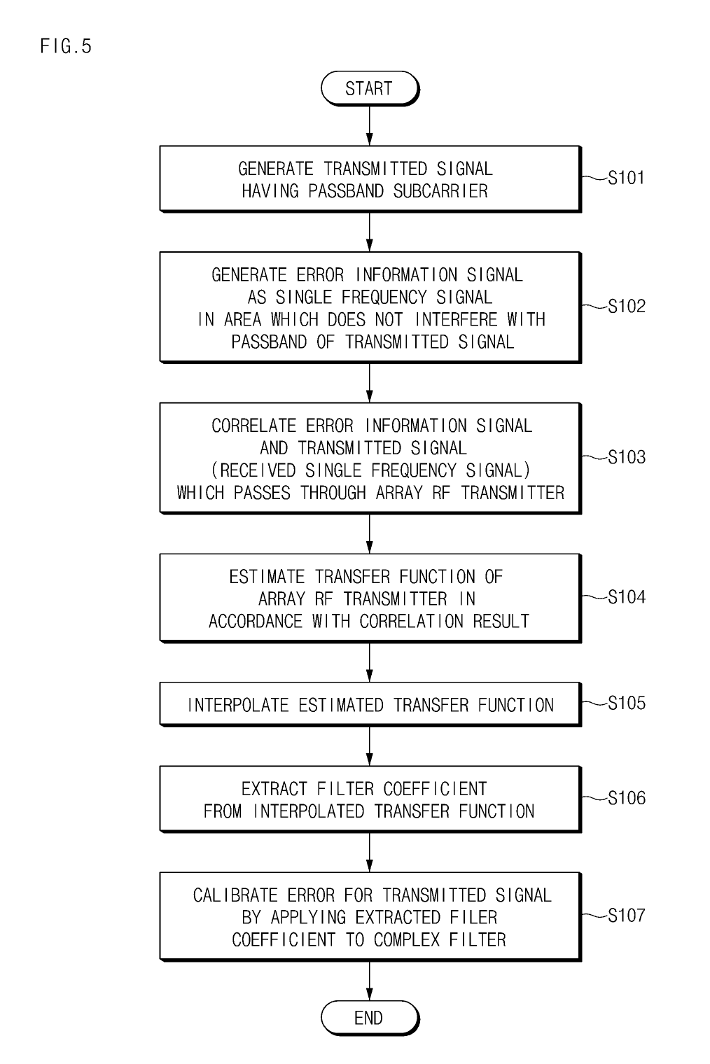

Hereinafter, an error calibrating method of an array transmitting antenna system according to an exemplary embodiment of the present invention will be specifically described with reference to FIG. 5.

The modulator 110 generates a transmitted signal having a passband subcarrier in step S101. Next, an error calibrating signal is generated with the single frequency signal in an area which does not interfere with the passband of the transmitted signal in step S102.

Thereafter, the error calibration estimator 190 correlates the transmitted signal (received single frequency signal) which passes through the array RF transmitter 150 and the error calibrating signal output from the calibrating signal generator 120 in step S103, to estimate the transfer function of the array RF transmitter 150 in accordance with the correlation result in step S104.

Thereafter, the error calibration estimator 190 interpolates the estimated transfer function in step S105 and extracts a filter coefficient from the interpolated transfer function in step S106.

Next, the error calibration estimator 190 applies the extracted filter coefficient to the array complex filter 140 to perform the error calibration of the transmitted signal in step S107.

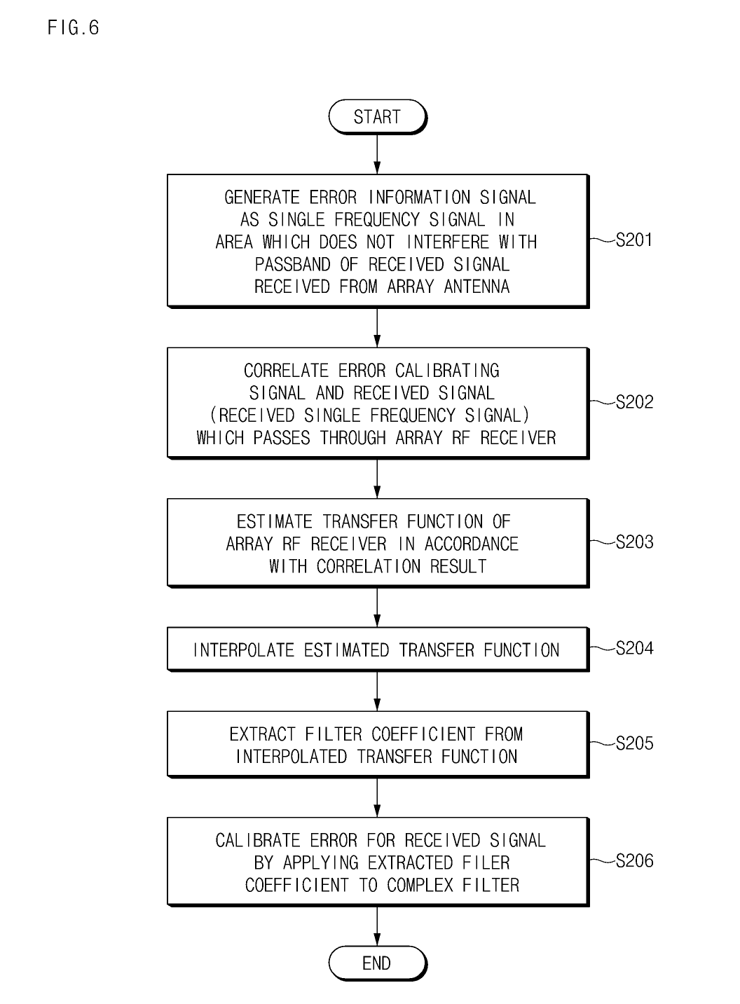

Hereinafter, an error calibrating method of an array receiving antenna system according to an exemplary embodiment of the present invention will be specifically described with reference to FIG. 6.

First, the calibrating signal generator 250 generates an error calibrating signal as a single frequency signal in an area which does not interfere with the passband of a received signal which is received from the array antenna 210 in step S201.

The array error calibration estimator 240 correlates the received signal (the received single frequency signal) which passes through the array RF receiver 220 and the error calibrating signal in step S202 and estimates the transfer function of the array RF receiver 220 in accordance with the correlation result in step S203.

Next, the array error calibration estimator 240 interpolates the estimated transfer function in step S204 and extracts the filter coefficient of the array complex filter 210 from the interpolated transfer function in step S205.

Next, the array error calibration estimator 240 applies the extracted filter coefficient to the array complex filter to perform the error calibration of the received signal in step S206.

According to the present invention, an error calibrating signal which does not interfere with a transmitted signal or a received signal of an array antenna is used to estimate an accurate transfer function and thus it is possible to accurately calibrate an error.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

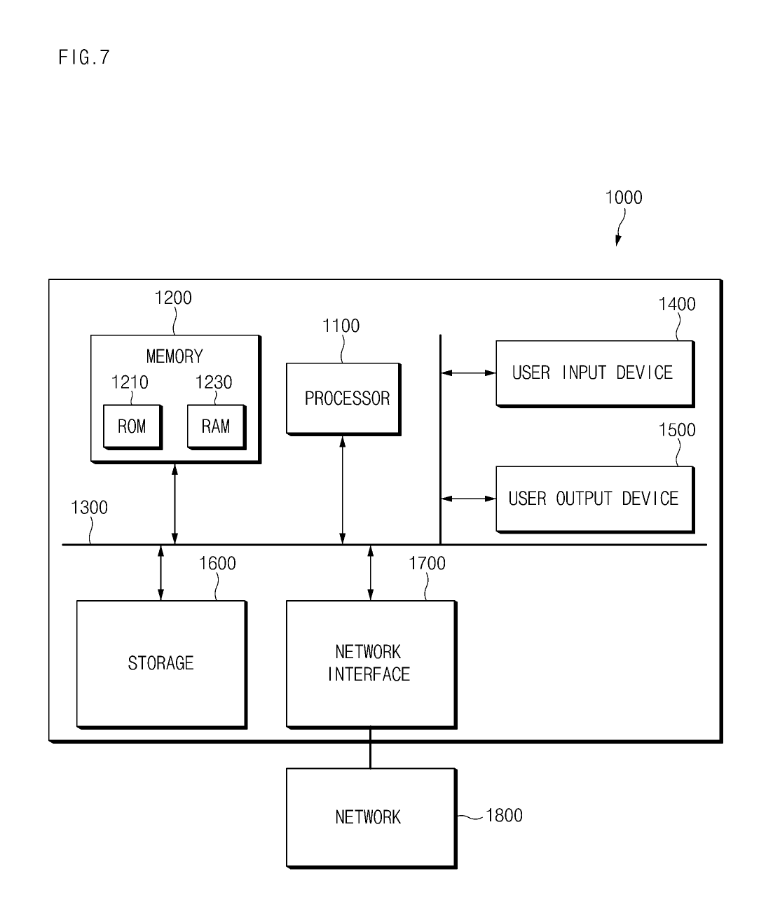

An embodiment of the present invention may be implemented in a computer system, e.g., as a computer readable medium. As shown in in FIG. 7, a computer system 120-1 may include one or more of a processor 121, a memory 123, a user input device 126, a user output device 127, and a storage 128, each of which communicates through a bus 122. The computer system 120-1 may also include a network interface 129 that is coupled to a network. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory (RAM) 125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The specified matters and limited exemplary embodiments and drawings such as specific elements in the present invention have been disclosed for broader understanding of the present invention, but the present invention is not limited to the exemplary embodiments, and various modifications and changes are possible by those skilled in the art without departing from an essential characteristic of the present invention. Therefore, the spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

What is claimed is:

1. An error calibrating apparatus of an array transmitting antenna system having a plurality of array antennas, the apparatus comprising:
a calibrating signal generator which generates an error calibrating signal as a single frequency signal, in an area which does not interfere with a passband of a transmitted signal;
an array RF transmitter which upwardly converts the transmitted signal into an RF band to transmit the signal to the plurality of array antennas;
an error calibration estimator which correlates the error calibrating signal and the receiving single frequency signal received by passing through the array RF transmitter to estimate a transfer function of the array RF transmitter and extract a filter coefficient using the estimated transfer function; and
a complex filter which calibrates an error of the transmitted signal by applying the filter coefficient to output the corrected transmitted signal to the array RF transmitter.

2. The apparatus of claim 1, further comprising:
a modulator which outputs a subcarrier transmitted signal at a passband;
an adder which adds the subcarrier transmitted signal of the passband output from the modulator and the error calibrating signal output from the calibrating signal generator; and
a beam former which multiples a weight and a transmitted signal by being added by the adder.

3. The apparatus of claim 1, wherein the calibrating signal generator generates at least one of single frequency signals of both end of the passband of the transmitted signal and DC component signal as the error calibrating signal.

4. The apparatus of claim 3, wherein the calibrating signal generator generates the single frequency signal so as to have the same interval as an interval of subcarriers in the passband of the transmitted signal.

5. The apparatus of claim 1, wherein the error calibration estimator includes:
a single frequency correlator which correlates the error calibrating signal and a receiving single frequency signal output from the array RF transmitter;
a transfer function estimator which estimates a transfer function in accordance with the correlation result;
a transfer function interpolator which interpolates the transfer function;
a filter coefficient extractor which extracts a filter coefficient from the interpolated transfer function; and
a storing unit which stores the filter coefficient.

6. The apparatus of claim 5, further comprising:
an RF receiver which downwardly converts the transmitted signal which is received from the array RF transmitter; and
an RF switch which sequentially connects the array RF transmitter and the RF receiver.

7. An error calibrating apparatus of an array receiving antenna system having a plurality of array antennas, the apparatus comprising:
a calibrating signal generator which generates an error calibrating signal as a single frequency signal, in an area which does not interfere with a passband of a received signal received from the plurality of array antennas;
an adder which couples the error calibrating signal and the received signal;
an array RF receiver which converts the coupled received signal into a base band signal;
an array complex filter which calibrates an error of the received signal transmitted from the array RF receiver; and
an error calibration estimator which correlates the error calibrating signal and a received single frequency signal which is received from the array complex filter to estimate a transfer function of the array RF receiver, and extracts a filter coefficient of the array complex filter using the estimated transfer function.

8. The apparatus of claim 7, further comprising:
an RF transmitter which upwardly converts an error calibration signal output from the calibrating signal generator into an RF band; and
an RF divider which transmits the error calibrating signal which is received from the RF transmitter to the adder.

9. The apparatus of claim 7, wherein the calibrating signal generator generates at least one of single frequency signals of both ends of the passband of the received signal or the DC component signal as the error calibrating signal.

10. The apparatus of claim 9, wherein the calibrating signal generator generates the single frequency signal to have the same interval as an interval of subcarriers in the passband of the received signal.

11. The apparatus of claim 1, wherein: the error calibration estimator includes:
a single frequency correlator which correlates the error calibrating signal and a receiving single frequency signal output from the array RF receiver;
a transfer function estimator which estimates a transfer function in accordance with the correlation result;
a transfer function interpolator which interpolates the transfer function;
a filter coefficient extractor which extracts a filter coefficient from the interpolated transfer function; and
a storing unit which stores the filter coefficient.

12. An error calibrating method of an array antenna system, the method comprising:
generating a transmitted signal having a passband subcarrier;
generating an error calibrating signal as a single frequency signal, in an area which does not interfere with a passband of the transmitted signal;
outputting the transmitted signal to an array RF transmitter:
correlating the error calibrating signal and a transmitted signal output from the array RF transmitter;
estimating a transfer function of the array RF transmitter in accordance with the correlation result;
interpolating the transfer function;
extracting a filter coefficient from the interpolated transfer function; and
applying the filter coefficient to the complex filter to perform calibration.

13. The method of claim 12, further comprising:
coupling the error calibrating signal and the transmitted signal; and
filtering the coupled transmitted signal in the complex filter.

14. The method of claim 12, wherein in the generating of an error calibrating signal, at least one of single frequency signals of both ends of the passband of the transmitted signal or the DC component signal is generated as the error calibrating signal.

15. The method of claim 14, wherein in the generating of an error calibrating signal, the single frequency signal is generated so as to have the same interval as an interval of subcarriers in the passband of the transmitted signal.

16. An error calibrating method of an array antenna system, the method comprising:
receiving a received signal having a passband subcarrier;
generating an error calibrating signal as a single frequency signal, in an area which does not interfere with a passband of the received signal;
coupling the error calibrating signal and the received signal to transmit the coupled signal to an array RF receiver;
converting the coupled received signal to a base band in the array RF receiver;
filtering the converted received signal in a complex filter;
correlating an output signal of the complex signal and the error calibrating signal to estimate a transfer function of the array RF receiver;
interpolating the transfer function;
extracting a filter coefficient from the interpolated transfer function; and
applying the filter coefficient to the complex filter to perform calibration.

17. The method of claim 16, wherein in the generating of an error calibrating signal, at least one of single frequency signals of both ends of the passband of the received signal or the DC component signal is generated as the error calibrating signal.

18. The method of claim 17, wherein in the generating of an error calibrating signal, the single frequency signal is generated so as to have the same interval as an interval of subcarriers in the passband of the received signal.
